(19) United States
(12) Patent Application Publication
(10) Pub. No.: US 2006/0206458 A1
(43) Pub. Date: Sep. 14, 2006

(54) Serving program elements through a unified interface

(76) Inventor: Paul Tyma, Syracuse, NY (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/078,852

(22) Filed: Mar. 9, 2005

(51) Int. Cl. G06F 17/30

(52) U.S. Cl. 707/3

(57) ABSTRACT

Serving program elements through a unified interface. A request for a program element is received at a unified interface from a requester, wherein the unified interface presents a uniform abstraction of program elements from sources accessible by the unified interface. The program element is searched for by the unified interface. The program element is provided to the requester.

### BACKGROUND

1. Field

Embodiments of the invention relate to the field of computer systems and more specifically, but not exclusively, to serving program elements through a unified interface.

2. Background Information

Contemporary computer languages, such as Java and C#, tend to be dynamically-linked as opposed to older languages, such as C and C++, which are statically-linked. The pertinent difference is that dynamically-linked languages are “constructed” as they execute (or are compiled). For example, a program element named “DrawingPad” which contains functionality to control a drawing surface on a computer monitor may need a program element named “Rectangle” that will provide functionality that will allow completion of a drawing task. The dynamic-linking system will then conduct a search for the “Rectangle” program element while the “DrawingPad” program element waits.

In Java, program elements are commonly stored as data files with a suffix of ‘.class’ which indicates that file is an object-oriented class encapsulating some given functionality and associated data. For example, one class may encapsulate the functionality and data for a button on a Graphical User Interface (GUI), while another class may encapsulate the functionality and data for a company payroll program. Java program elements may include images, sounds, icons, serialized objects (e.g., stored state objects) or any other files required for correct execution of a given Java program.

As an example, in the Java language environment it is common to find program elements stored on hard disks as files, in compressed archives, in uncompressed archives, or remotely downloaded. If the program elements are located in disk directories or archives, a facility called CLASSPATH is commonly used to specify where the compiler or runtime environment should search for any program elements it may need.

CLASSPATH may be limited to specifying local sources. Use of the CLASSPATH forces a person wishing to run (or compile) a Java program to find all possible destinations of program elements (e.g., directories, archives, etc.) and correctly and precisely specify each one. Given that Java programs are often made of program elements created by many persons, this can be an arduous process. To alleviate a user from having to construct a CLASSPATH, it's common for programmers wishing to distribute their software to create scripts to build a CLASSPATH.

Java programs may also work with a class loader (CL). In general, a CL enables the Java Virtual Machine (JVM) to load classes without knowing anything about the underlying files system of the classes. A CL also allows Java programs to dynamically load Java classes as extension modules.

Further, a programmer may create a custom class loader. A custom CL may load many program elements from wherever the programmer specifies. A custom CL can replace, ignore, or work in conjunction with the CLASSPATH.

Class loaders have several traits. First, a class loader must be created and used in the client program. For example, a Java program must be engineered to use a particular CL from the start (or engineered to work within a framework that dictates custom CLs). In contrast, a CLASSPATH is effectively transparent to the Java program. Second, a client program cannot simultaneously use two class loaders. Thus, it may be impossible to create a custom class loader for an application that already uses a different class loader.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 is a block diagram illustrating one embodiment of serving program elements through a unified interface in accordance with the teachings of the present invention.

FIG. 2 is a block diagram illustrating one embodiment of serving program elements through a unified interface in accordance with the teachings of the present invention.

FIG. 3 is a block diagram illustrating one embodiment of serving program elements through a unified interface in accordance with the teachings of the present invention.

FIG. 4 is a block diagram illustrating one embodiment of serving program elements through a unified interface in accordance with the teachings of the present invention.

FIG. 5 is a flowchart illustrating one embodiment of the logic and operations to serve program elements through a unified interface in accordance with the teachings of the present invention.

FIG. 6 is a block diagram illustrating one embodiment of a computer system to implement embodiments of the present invention.

### DETAILED DESCRIPTION

In the following description, numerous specific details are set forth to provide a thorough understanding of embodiments of the invention. One skilled in the relevant art will recognize, however, that embodiments of the invention can be practiced without one or more of the specific details, or with other methods, components, materials, etc. In other instances, well-known structures, materials, or operations are not shown or described in detail to avoid obscuring understanding of this description.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Embodiments of serving program elements through a unified interface is disclosed. According to one embodiment, program elements are gathered from many sources. These sources may include disk files, compressed or uncompressed archive files, or remote locations. The true locations of the sources are abstracted and the elements are presented in a uniform interface.

In one embodiment, the uniform presentation of program elements is accomplished by emulating a disk device and allowing operating systems to “mount” the emulated device. At this point, requesting programs can simply search this emulated disk device for required program elements when in actuality embodiments described herein abstract the true locations and formats.

Embodiments described herein remove the limitations and complexities associated with using CLASSPATH and class loaders. Program elements may be specified, loaded, and created in a uniform manner. Further, embodiments herein allow the simultaneous use of CLASSPATH and class loaders by a program.

The Java programming language from Sun Microsystems is used as an example throughout the following description because of its applicability to requesting program elements during compilation and runtime (“Java” and “Sun” are trademarks of Sun Microsystems, Inc.). Other dynamically-linked languages such as any language compiling to Java Bytecode or the .NET framework (e.g., C#, VB.NET, etc.) are also applicable (“.NET”, “C#”, and “VB.NET” are trademarks of the Microsoft Corporation). However, it will be understood that embodiments of the present invention are not limited to Java, or any other particular programming language.

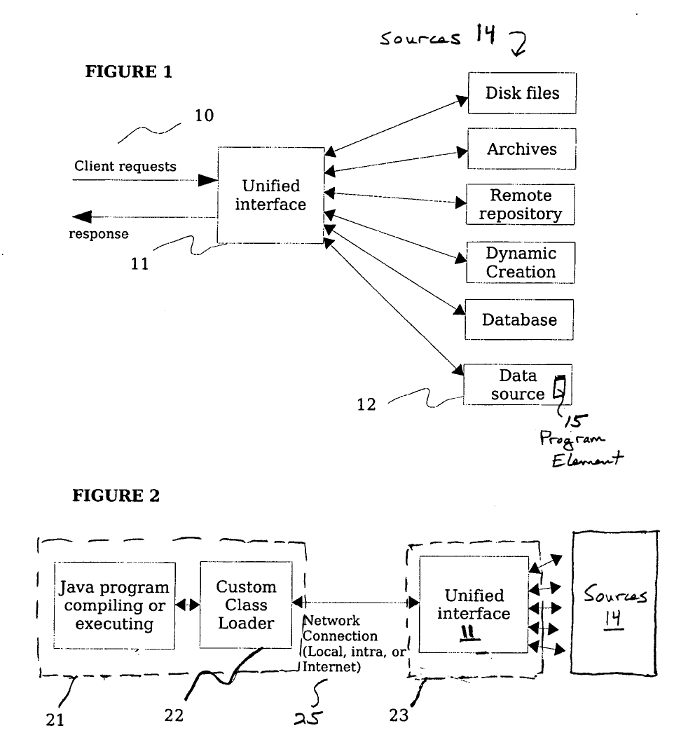

Referring to FIG. 1, a unified interface 11 in accordance with one embodiment of the present invention is shown. In one embodiment, unified interface 11 serves (or denies) program elements in response to client requests 10. Program elements may include static, passive data residing on disk drives or in archives. Unified interface 11 may dynamically serve program elements from various locations at the same time. Unified interface 11 may also create program elements upon request.

In one embodiment, unified interface 11 abstracts the locations of program elements from sources 14. Sources 14 include disk files, archives, remote repositories (e.g., remote instances of the unified interface 11), dynamic creation, a database holding program elements, or any other data source 12 capable of containing program elements. One or more of the sources 14 may be locally connected to unified interface 11 or connected to unified interface 11 via a network connection. FIG. 1 shows program element 15 stored at data source 12. Note that the data source 12 represents any type of data source. Unified interface 11 enables programs, such as Java programs, to utilize program elements from sources 14.

In one embodiment, program elements may be dynamically created by unified interface 11 according to some set of rules. One example is a request for a program element that prints the day of the week. Such a program element may be tailored to the local language of the user running the program. It will be appreciated that the set of possible rules for creation of program elements is unbounded.

Turning to FIG. 2, an embodiment of serving program elements is illustrated. Unified interface 11 abstracts specified program elements into a unified view that is presented via a networked server 23. In one embodiment, server 23 executing unified interface 11 provides a listening network port(s) where clients, such as client 21, may connect and request program elements (or simply lists of program elements). In this particular embodiment, requesting client 21 may know it is interfacing with unified interface 11.

Server 23 and client 21 may be connected by a network connection 25. Network connection 25 may include a local network, an intranet, an internet, or any combination thereof. Network connection 25 may include wired connections, wireless connections, or any combination thereof.

There is no inherent support in releases of Java 1.5 or prior for native access as shown in FIG. 2. Thus, a programmer may create a custom class loader 22 to facilitate this access. Note that activating multiple class loaders simultaneously is difficult in Java (hence the difficulty of a native Java program accessing all the sources 14 shown in FIG. 1). However, if one class loader, such as custom CL 22, is created to specifically interact with unified interface 11, this problem is removed. In the embodiment of FIG. 2, a Java program being compiled or being executed may find required program elements across possible sources 14 through custom class loader 22 interacting with unified interface 11.

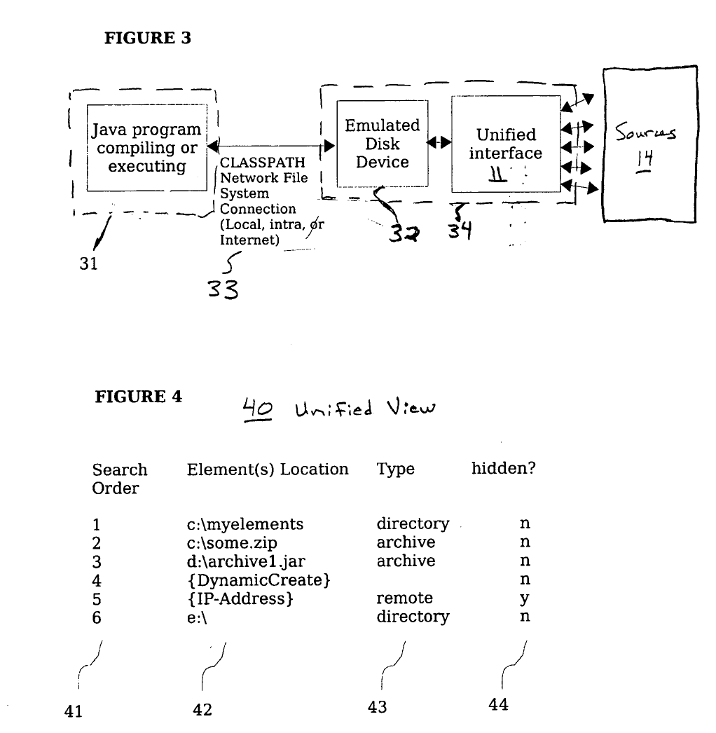

Referring to FIG. 3, another embodiment of serving program elements is shown. An emulated disk device 32 on server 34 is provided that interacts with unified interface 11. A client 31 may communicate with emulated disk device 32 instead of directly accessing unified interface 11. Client 31 may use a network file system connection 33 to access emulated disk device 32. Network file system connection 33 may include a local network, an intranet, or an internet, or any combination thereof. Network file system connection 33 may include wired connections, wireless connections, or any combination thereof.

In the embodiment of FIG. 3, program elements may be transparently served to any requester that knows how to access a disk (described further below). In the embodiment of FIG. 3, the client 31 may not be aware it is actually interfacing with unified interface 11.

Turning to FIG. 4, an embodiment of a unified view 40 is shown. Unified view 40 allows program elements from many sources to be presented in such a way that any or all of the program elements may be accessed the same way. In reality, the elements could reside in vastly different places with significantly different ways of access. For example, one program element could be a local disk file whereas another could be sent via a custom protocol across a network. Unified view 40 shows types 43 of various program elements.

In one embodiment, program elements may be specified by the user of the unified interface 11. In another embodiment, the user of the unified interface 11 may specify one or more locations (e.g., remote network location, disk directory, etc.) and the location(s) may be recursively searched for program elements. In yet another embodiment, if during the recursive search for program elements, an archive file (compressed or uncompressed) is encountered, then the archive may be opened to scan for program elements in the archive. To open the archive, the archive may be decompressed, decrypted, and/or expanded.

In one embodiment, unified view 40 may present program elements as leaves of a tree structure representing a hierarchical naming system. In another embodiment, program elements may simply be a linear list 42 of all program elements. In Java, class files often have a package designation which has portions delimited by periods. For example, a class may be named com.outscheme.drawing.Rectangle

In one embodiment, program elements are presented in a unified view that is most effective to clients requesting program elements. In one embodiment, unified view 40 may be presented to human user for configuring unified interface 11. In another embodiment, unified view 40 may be presented in a way for use by a process, such as processes requesting program elements during compilation, linking, and execution of a program. In one embodiment, program elements may be presented in a unified view to clients requesting program elements for purposes of compilation and execution. Specifically, compilation and execution of a program may require program elements as those processes progress.

In one embodiment, any program element may be executed such that the program element will then invoke subsequent program elements in a cascading fashion. Languages such as Java have a loose interpretation of the concept of a “computer program.” Analysis can determine definitive program entry points. Typically, but not necessarily, the cascading of program elements will result in the execution of some intended computer program.

In one embodiment, a user may use unified view 40 to add or remove individual program elements or sets of program elements. Program elements tend to be clustered by design (e.g., all program elements that make up a library for drawing Microsoft Windows boxes). The program elements then are collected and distributed together in program element collections. These program element collections may be organized into directory repositories or archives. A user may selectively add or delete program element collections using unified view 40. A collection is still viable even if it has only one encompassed program element.

In another embodiment, a user may order how the program elements are searched using a search order 41. If all program elements have different names then ordering is not of significant consequence. However, in the cases where name collisions occur, the first listed program element dictates which version of some program element will be delivered to a requester.

For example, a programmer may wish to create a program which uses a third-party library which comes in several versions. For quick testing, a programmer may add both versions of the third-party library as sources to the unified interface. Different versions of the same third-party library may contain many like named program elements. For testing, the programmer may switch the ordering of those libraries to determine how a program reacts to the different library versions. During execution, the program requests program elements from the library version listed first in the search order 41.

In another embodiment, a user may selectively hide one or more program elements from some or all requesting clients using a hidden field 44. Removing the program elements from the unified interface's repository would remove the program elements from the view of all requesters. The program elements may be hidden from clients based upon Internet Protocol (IP) address, locality, login, or any other criteria to distinguish clients.

In another embodiment, a user may save a list of program elements and/or collections for later restoration. In one embodiment, the list is saved to a persistent storage, such as a hard disk. Anytime unified interface 11 is restarted, it may be restored to any previously configured state that has been saved.

In one embodiment, unified interface 11 listens on advertised ports of a server for specific requests for program elements. Requesters making requests on these advertised ports may use a custom protocol of unified interface 11. In one embodiment, requesters include other unified interfaces requesting program elements on behalf of their clients. In another embodiment, requesters include standalone clients designed to interact with the unified interface to fetch program elements. An advertised port entry into the unified interface may be available to requesters simultaneously with the emulated disk device embodiment described below.

In an embodiment using emulated disk device 32, the server is available on network ports communicating via a network file system protocol. This includes emulation of protocols such as Network File System (NFS), Common Internet File System (CIFS), or Server Message Block (SMB). In addition, alternative or custom network file system protocols may also be used.

In another embodiment, the availability of the network file system protocol allows transparent integration into the CLASSPATH mechanism thus fully integrating unified interface 11 into all existing Java environments with no modification.

In the emulated disk device embodiment of providing an entry point, any software program that understands how to interface with disk devices may interface with unified interface 11. For example, program elements could be copied from the sources through the emulated disk device using normal operating system copy facilities. Such copy facilities include the “cp” command in Unix and the Microsoft Windows “drag and drop” copying functionality.

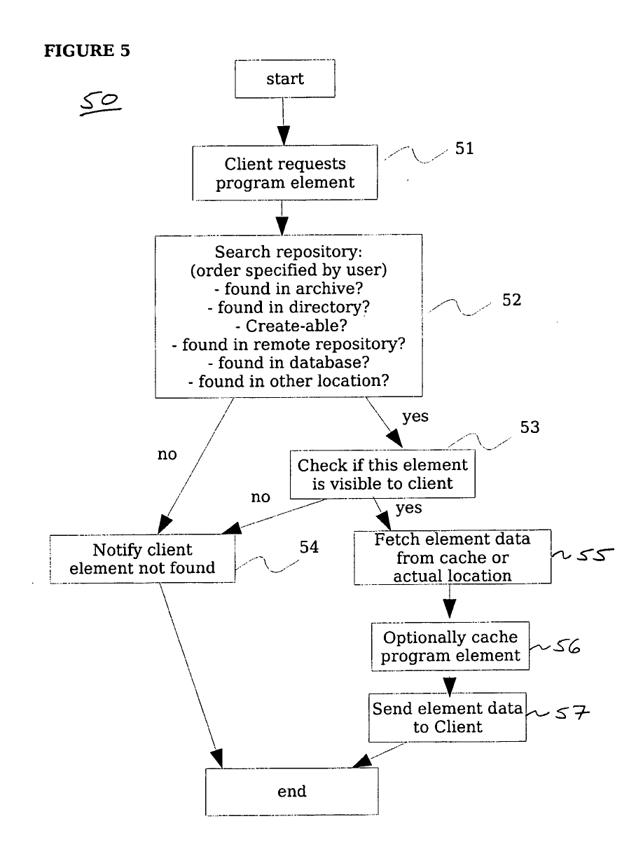

Turning to FIG. 5, a flowchart 50 illustrates the logic and operations to serve program elements through a unified interface in accordance with one embodiment of the present invention. Starting in a block 51, a client requests a program element. In one embodiment, the client requests the program element for compilation or execution of a Java program. In another embodiment, the client requests the program element for local storage or examination.

Proceeding to a block 52, the unified interface searches for the requested program element. In one embodiment, unified interface searches the sources for the requested program element. In another embodiment, the unified interface maintains a repository of information regarding the program elements stored at the sources. This repository may be cached at the unified interface. The repository may also be updated by periodically searching the sources for new or removed program elements.

In one embodiment, the unified interface searches for program elements in the order listed in the unified view. Specific ordering of the program elements may be configured by a user.

If the requested program element is not found, then the logic proceeds to a block 54 to notify the client of the failure. In the embodiment of a Java program requester, the Java program would issue a ClassNotFoundException.

If the program element is located, then the logic continues to a block 53 to determine whether this client has visibility for this program element. The visibility parameters may be user configured using the hidden field 44 of the unified view 40. If the program element is hidden from the client, then the logic proceeds to block 54.

If the program element is not hidden from the client, then the logic continues to a block 55 where the program element is fetched. In one embodiment, the program element may be fetched from a cache accessible to the unified interface. In another embodiment, the program element is fetched from its source location.

Proceeding to a block 56, the program element may be optionally cached at the unified interface. By caching a program element, the unified element may quickly access the program element if it is requested again by the current requester or a different requester. Continuing to a block 57, the program element is sent to the client.

Many program elements have dependencies upon program elements owned by third parties. In many cases, but not all, such third-party program elements must be present for correct program execution.

In one embodiment, unified interface 11 may be configured to be aware of Internet download locations of third-party program elements or program element collections. In another embodiment, by way of configuration or detection, unified interface 11 may automatically update (e.g., download and/or install) third-party program elements or collections. This may be done via automatic monitoring of the third-party vendor's website or via direct configuration or command.

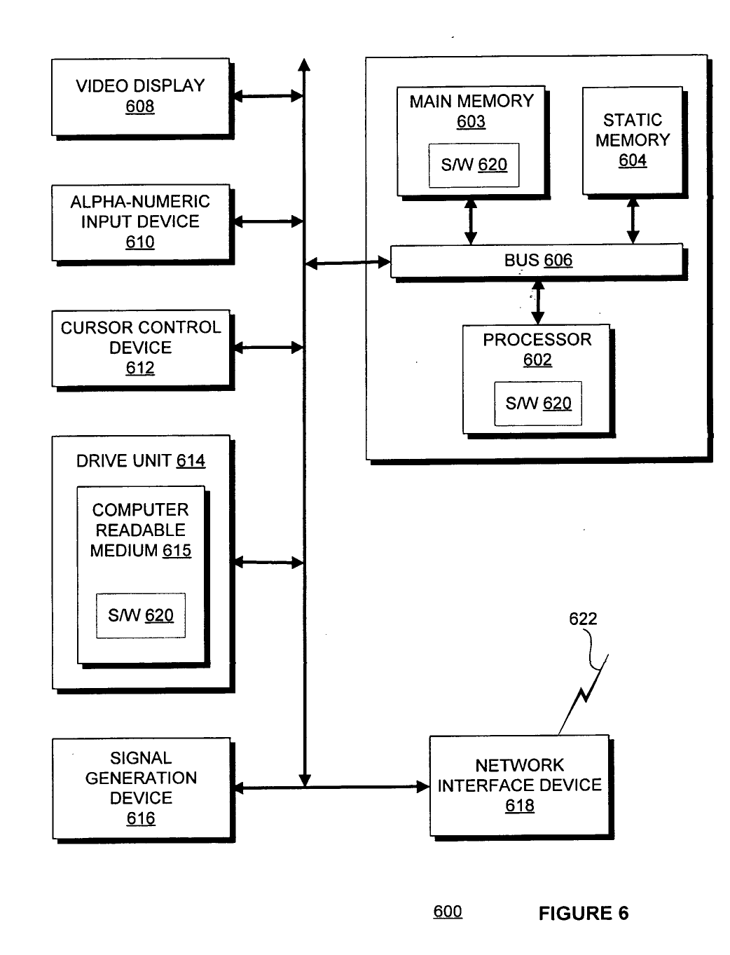

Referring to FIG. 6, an embodiment of a computer system 600 for implementing embodiments of the present invention is shown. In one embodiment, software for performing embodiments of the present invention may be executed on computer system 600. In yet another embodiment, computer system 600 includes a server to execute a unified interface as described herein.

Computer system 600 includes a processor 602, a main memory 603, which communicate via a bus 606. Computer system 600 may also include a video display unit 608 (e.g., a liquid crystal display or a cathode ray tube (CRT) or the like). The computer system 600 also includes an alpha-numeric input device 610 (e.g., a keyboard), a cursor control device 612 (e.g., a mouse or a trackball or the like), a disk drive unit 614, a signal generation device 616 (e.g., a speaker) and a network interface device 618. The disk drive unit 614 includes a computer-readable medium 615 on which software 620 is also shown to reside, completely or at least partially, within the main memory 603 and/or within the processor 602. The software 620 may further be transmitted or received via the network interface device 618.

For the purposes of the specification, the term “computer-readable medium” shall be taken to include any medium which is capable or storing or encoding a sequence of instructions for execution by a processor and that cause the processor to perform the methodologies of embodiments of the present invention. The term “computer-readable medium” shall be taken to include, but not be limited to, solid-state memories, optical and magnetic disks and carrier wave signals 622, which in one embodiment may be received through network interface device 618.

The flowchart described above may be implemented by computer software, computer hardware, or any combination thereof. The flowchart blocks described may constitute instructions embodied within a machine-readable medium, that when executed by a machine (e.g., a computer system) will cause the machine to perform the operations described. Additionally, the flowchart blocks may be embodied within hardware, such as an Application Specific Integrated Circuit (ASIC), or the like. The order in which some or all of the blocks appear in the flowchart should not be deemed limiting. Rather, one of ordinary skill in the art having the benefit of the present disclosure will understand that the flowchart blocks may be executed in a variety of orders.

The above description of illustrated embodiments of the invention, including what is described in the Abstract, is not intended to be exhaustive or to limit the embodiments to the precise forms disclosed. While specific embodiments of, and examples for, the invention are described herein for illustrative purposes, various equivalent modifications are possible, as those skilled in the relevant art will recognize. These modifications can be made to embodiments of the invention in light of the above detailed description.

The terms used in the following claims should not be construed to limit the invention to the specific embodiments disclosed in the specification. Rather, the following claims are to be construed in accordance with established doctrines of claim interpretation.

What is claimed is:

1. A method, comprising:
receiving a request for a program element at a unified interface from a requester, wherein the unified interface presents a uniform abstraction of program elements at sources accessible by the unified interface;
searching for the program element by the unified interface; and
providing the program element to the requester.

2. The method of claim 1 wherein the sources include at least one of a disk file, an archive, a remote repository, a database, a data source, and program elements dynamically created by the unified interface.

3. The method of claim 1, further comprising:
sending a failure message to the requester if the program element is not found; and
sending a failure message to the requester if the program element is found and the program element is to be hidden from the requester.

4. The method of claim 1 wherein searching for the program element includes searching for the program element according to a predetermined search order of program elements.

5. The method of claim 1 wherein searching for the program element includes searching for the program element in a repository of program element information maintained by the unified interface, the program element information gathered by scanning the sources for the program elements.

6. The method of claim 1, further comprising caching the program element at the unified interface.

7. The method of claim 1, further comprising generating a unified view of program element information regarding the program elements by the unified interface.

8. The method of claim 7, further comprising using the unified view to add/remove program elements that may be provided by the unified interface.

9. The method of claim 1, further comprising emulating a disk device by the unified interface, wherein the requester perceives the program elements as being stored on the disk device.

10. The method of claim 1, further comprising listening on advertised ports of a server for the request, wherein the unified interface executes on the server.

11. The method of claim 1 wherein the request is made by a custom class loader interfaced with the requester, wherein the requester is a program residing on a client.

12. The method of claim 11 wherein the custom class loader provides simultaneous access of a class loader and a CLASSPATH for the program.

13. The method of claim 1, further comprising saving the program element, wherein the unified interface may be restored using the saved program element.

14. The method of claim 1, further comprising providing a second program element to the requester, wherein the program element invoked the second program element.

15. An article of manufacture comprising:
a machine-readable medium including a plurality of instructions which when executed perform operations comprising:
receiving a request for a program element from a client at a unified interface executing on a server, wherein the unified interface presents a uniform view of program elements stored on sources accessible by the server;
searching for the program element by the unified interface;
fetching the program element by the unified interface; and
sending the program element to the client.

16. The article of manufacture of claim 15 wherein execution of the plurality of instructions further perform operations comprising:
notifying the client of a failure if the program element is not found by the unified interface; and
notifying the client of a failure if the program element is found by the unified interface and the program element is to be hidden from the client by the unified interface.

17. The article of manufacture of claim 15 wherein execution of the plurality of instructions further perform operations comprising presenting the program elements to the client as being stored on an emulated disk device at the server, wherein the client to access the emulated disk device using a network file system protocol.

18. The article of manufacture of claim 15 wherein execution of the plurality of instructions further perform operations comprising caching the program element on the server.

19. The article of manufacture of claim 15 wherein searching includes searching for the requested program element according to a predetermined search order.

20. The article of manufacture of claim 15 wherein execution of the plurality of instructions further perform operations comprising scanning the sources to update a repository of available program elements maintained by the unified interface.

21. The article of manufacture of claim 15 wherein execution of the plurality of instructions further perform operations comprising generating a unified view available to a user for configuring the unified interface.

22. A method, comprising:
scanning a plurality of sources connected to a first unified interface for program elements, wherein the first unified interface resides on a server to provide a uniform abstraction of the program elements to a client connected to the server;
storing location information regarding the program elements in a repository at the first unified interface;
providing a unified view of the program elements by the first unified interface; and
sending a first program element to a program residing on the client in response to a request for the first program element.

23. The method of claim 22, further comprising sending a second program element to the client in response to a request from the first program element.

24. The method of claim 22, further comprising sending a second program element to a second unified interface in response to a request from the second unified interface.

25. The method of claim 22, further comprising requesting a second program element from a second unified interface by the first unified interface.

26. The method of claim 22, further comprising simultaneously listening for program element requests at a port of the server and emulating a disk device on the server, the disk device to appear to the client as having stored the program elements.

27. The method of claim 22, further comprising creating a second program element by the unified interface.

28. The method of claim 22, further comprising monitoring a third-party website to determine if updates are available for the first program element.

29. The method of claim 22 wherein scanning the plurality of sources includes opening an archive file to enable scanning of the archive file for program elements.
